(19) United States
(12) Patent Application Publication
(10) Pub. No.: US 2021/0312144 A1
(43) Pub. Date: Oct. 7, 2021

(54) TRANSLATION DEVICE, TRANSLATION METHOD, AND PROGRAM

(71) Applicant: Panasonic Intellectual Property Management Co., Ltd., Osaka (JP)

(72) Inventor: Kaito MIZUSHIMA, Hyogo (JP)

(21) Appl. No.: 17/354,211

(22) Filed: Jun. 22, 2021

Related U.S. Application Data
(63) Continuation of application No. PCT/JP2019/049200, filed on Dec. 16, 2019.

(30) Foreign Application Priority Data
Jan. 15, 2019 (JP) 2019-004402

(51) Int. Cl. G06F 40/58; G06F 40/51; G06F 40/42

(52) U.S. Cl. CPC G06F 40/58; G06F 40/42; G06F 40/51

(57) ABSTRACT

A translation device includes: an input interface that acquires an input sentence in a first language; and a controller that controls machine translation for the input sentence acquired by the input interface, wherein the controller acquires, based on the input sentence, a translated sentence showing a result of machine translation of the input sentence from the first language to a second language, acquires, based on the translated sentence, a reverse-translated sentence showing a result of machine translation of the translated sentence from the second language to the first language, and corrects, based on the input sentence, a part including a translated word in the acquired reverse-translated sentence to change the translated word into a phrase corresponding to a polysemous word in the input sentence, the translated word corresponding to the polysemous word of the translated sentence in the reverse-translated sentence.

### BACKGROUND

### 1. Technical Field

The present disclosure relates to translation devices, translation methods, and programs based on machine translation.

### 2. Related Art

JP 2006-318202 A discloses a translation device for a user to easily detect a mistranslation and correct a mistranslated portion of an original sentence. The translation device of JP 2006-318202 A generates a translated sentence obtained by translating the input original sentence in the first natural language into the second natural language, generates a reverse-translated sentence obtained by translating the translated sentence into the first natural language, and displays the translated sentence and the reverse-translated sentence in association with the original sentence. At this time, an original sentence translated word candidate list, which is a list of candidates for a translated word in the second natural language among morphemes of the original sentence, is created. When the operation member receives an instruction from the user, one candidate is selected from the original sentence translated word candidate list, and the translated sentence and the reverse-translated sentence are regenerated using the selected translated word as the translated word of the corresponding morpheme. In JP 2006-318202 A, the generation of a reverse-translated sentence is repeated in order to correct the mistranslation.

### SUMMARY

The present disclosure provides a translation device, a translation method, and a program capable of improving the accuracy of a reverse-translated sentence with respect to a translated sentence in which an input sentence is mechanically translated.

The translation device according to the present disclosure includes an input interface and a controller. The input interface acquires an input sentence in the first language. The controller controls machine translation for the input sentence acquired by the input interface. The controller acquires, based on the input sentence, a translated sentence showing a result of machine translation of the input sentence from the first language to the second language, and acquires, based on the translated sentence, a reverse-translated sentence showing a result of machine translation of the translated sentence from the second language to the first language. The controller corrects, based on the input sentence, a part including a translated word in the acquired reverse-translated sentence to change the translated word to a phrase corresponding to a polysemous word in the input sentence in the acquired reverse-translated sentence, the translated word corresponding to the polysemous word in the translated sentence.

These general and specific aspects may be realized by systems, methods, and computer programs, and combinations thereof.

In the translation device, translation method and program according to the present disclosure, it is possible to improve the accuracy of the reverse-translated sentence with respect to the translated sentence in which the input sentence is mechanically translated.

### BRIEF DESCRIPTION OF THE DRAWINGS

FIG. 1 is a diagram showing an outline of a translation system according to a first embodiment of the present disclosure.

FIG. 2 is a block diagram illustrating a configuration of a translation device according to the first embodiment.

FIG. 3 is a diagram for explaining a paraphrase target list in the translation device.

FIG. 4 is a block diagram illustrating a configuration of a translation server according to the first embodiment.

FIG. 5 is a diagram for explaining an operation of the translation system according to the first embodiment.

FIG. 6 is a flowchart showing an operation of the translation device according to the first embodiment.

FIG. 7A is a table illustrating various information acquired in the operation of the translation device.

FIG. 7B is a table illustrating a reverse-translated sentence of a correction result based on the information in FIG. 7A.

FIG. 8 is a flowchart illustrating processing of paraphrase correction of a reverse-translated sentence in the translation device.

FIG. 9 is a flowchart illustrating a paraphrase-target detection processing in the first embodiment.

FIG. 10 is a diagram illustrating an alignment table used for the paraphrase-target detection processing of the first embodiment.

FIG. 11 is a flowchart illustrating an inflection conversion processing in the first embodiment.

FIG. 12 is a diagram for explaining a trained model used for the inflection conversion processing of the first embodiment.

FIG. 13 is a flowchart showing a first modification of the paraphrase-target detection processing.

FIG. 14 is a diagram for explaining the first modification of the paraphrase-target detection processing.

FIG. 15 is a flowchart showing a second modification of the paraphrase-target detection processing.

### DESCRIPTION OF EMBODIMENTS

Hereinafter, an embodiment will be described in detail with reference to the drawings as appropriate. However, a detailed description more than necessary may be omitted in some cases. For example, a detailed description of a well-known item and a duplicate description for a substantially identical component may be omitted in some cases. This is to avoid an unnecessarily redundant description and to allow those skilled in the art to easily understand the following description.

In addition, the applicant provides the accompanying drawings and the following description in order for those skilled in the art to fully understand the present disclosure, and it is not intended to limit the subject matter described in the claims by these.

### First Embodiment

Hereinafter, the first embodiment of the present disclosure will be described with reference to the drawings.

1. Configuration

1-1. System overview

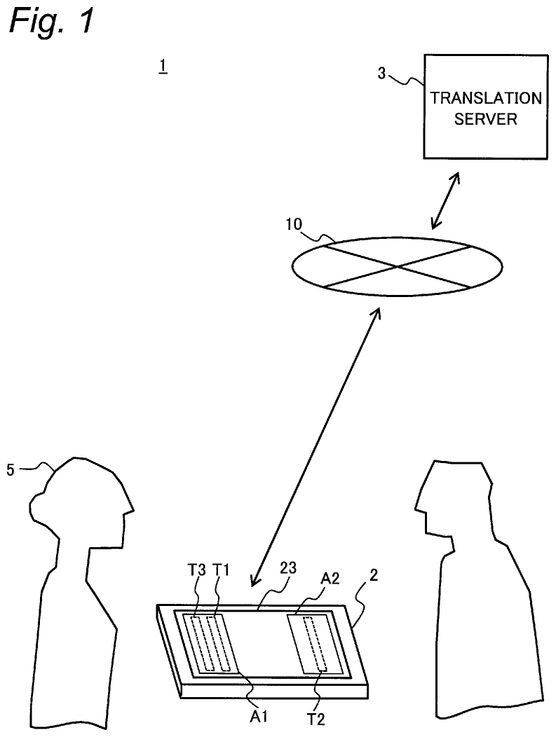

A translation system according to the first embodiment will be described with reference to FIG. 1. FIG. 1 is a diagram showing an outline of a translation system 1 according to the present embodiment.

The translation system 1 according to the present embodiment includes a translation device 2 used by a user 5 and a translation server 3 that executes machine translation between various bilingual languages. In the translation system 1 of the present embodiment, the translation device 2 performs data communication with the translation server 3 via a communication network 10 such as the Internet. The translation server 3 is, for example, an ASP server. The translation system 1 may include a plurality of translation devices 2. In this case, each translation device 2 appropriately includes identification information of its own device in data to be transmitted, and the translation server 3 can transmit data to the translation device 2 indicated by the received identification information.

In the translation system 1 of the present embodiment, the translation device 2 receives input such as an utterance content desired by the user 5, and the translation server 3 mechanically translates an input sentence T1 indicating the input content in a source language into a translated sentence T2 in a desired target language. As exemplified in FIG. 1, the translation device 2 of the present embodiment displays the input sentence T1 in a display area Al for a user to be shown to the user 5, and displays the translated sentence T2 in a display area A2 for the other party of the user 5. The source language is an example of the first language, and the target language is an example of the second language. The first and second languages can be set to various natural languages.

When using the translation system 1, the user 5 may want to check, in the source language, whether or not the translated sentence T2 as a result of machine translation for the input sentence T1 has the intended content, for example. Therefore, the translation system 1 of the present embodiment performs machine translation on the translated sentence T2 by the translation server 3 again, to display a reverse-translated sentence T3 obtained by retranslating the translated sentence T2 into the source language in the display area A1 for the user, for example. As a result, the user 5 can easily check the content of the translated sentence T2 by comparing the input sentence T1 and the reverse-translated sentence T3.

In the translation system 1 as described above, when the machine translation by the translation server 3 is successful without any mistranslation, it is desired that the input sentence T1 and the reverse-translated sentence T3 generally match, with the difference therebetween being small. In the present embodiment, the translation device 2 is provided that improves the accuracy of the reverse-translated sentence T3 in accordance with the input sentence T1, in order to avoid a situation in which the reverse-translated sentence T3 deviate from the input sentence T1 even though the machine translation on the translation server 3 is successful.

1-2. Configuration of translation device

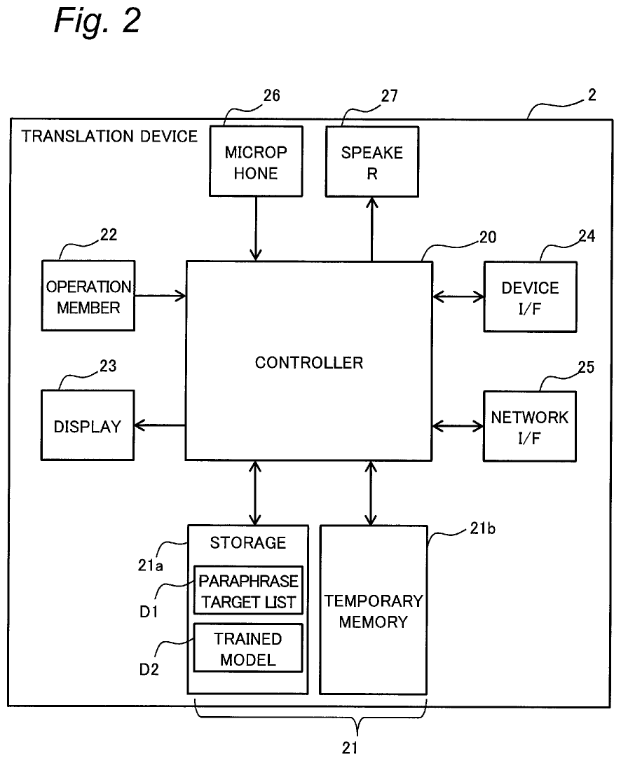

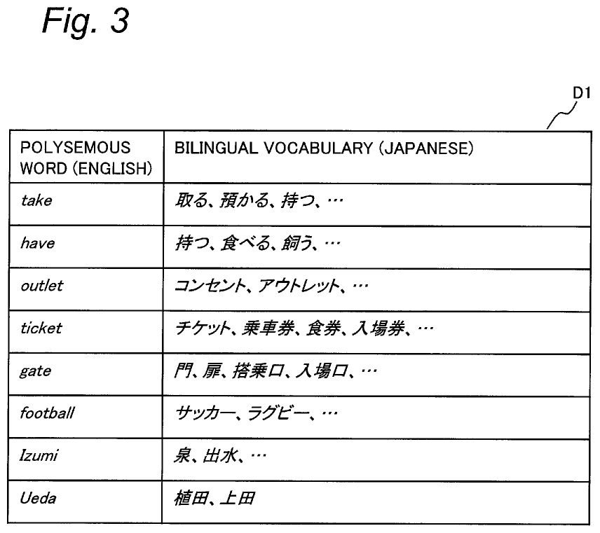

The configuration of the translation device 2 in the translation system 1 of the present embodiment will be described with reference to FIGS. 2 and 3. FIG. 2 is a block diagram illustrating the configuration of the translation device 2.

The translation device 2 is an information terminal such as a tablet terminal, a smartphone, or a PC, for example. The translation device 2 illustrated in FIG. 2 includes a controller 20, a memory 21, an operation member 22, a display 23, a device interface 24, and a network interface 25. Hereinafter, the interface may be abbreviated as “I/F”. Further, the translation device 2 includes a microphone 26 and a speaker 27, for example.

The controller 20 includes a CPU or MPU that realizes a predetermined function in cooperation with software, to control the overall operation of the translation device 2, for example. The controller 20 reads data and programs stored in the memory 21, and performs various arithmetic processes to realize various functions. For example, the controller 20 executes a program including a group of instructions for realizing the processing of the translation device 2 in the translation method of the present embodiment. The above program may be provided from the communication network 10 or the like, or may be stored in a portable recording medium.

Note that the controller 20 may be a hardware circuit such as a dedicated electronic circuit designed to realize a predetermined function or a reconfigurable electronic circuit. The controller 20 may include various semiconductor integrated circuits such as CPU, MPU, GPU, GPGPU, TPU, microcomputer, DSP, FPGA, and ASIC.

The memory 21 is a storage medium that stores programs and data necessary for realizing the functions of the translation device 2. As shown in FIG. 2, the memory 21 includes a storage 21a and a temporary memory 21b.

The storage 21a stores parameters, data, a control program, and the like for realizing a predetermined function. The storage 21a includes an HDD or an SSD, for example. For example, the storage 21a stores the above program, the paraphrase target list D1, the trained model D2, and the like.

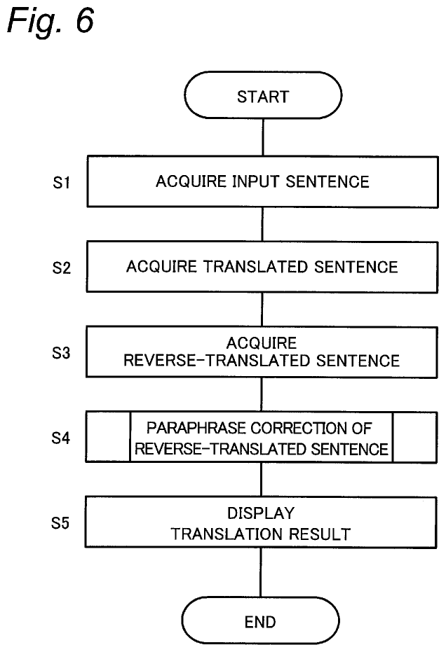

FIG. 3 is a diagram for explaining the paraphrase target list D1 in the translation device 2. The paraphrase target list D1 is a list of candidates to be paraphrased in the paraphrase correction (see FIG. 6) of the reverse-translated sentence described later. In the paraphrase target list D1, the polysemous words in the target language (e.g., English) and the bilingual vocabulary in the source language (e.g., Japanese) are registered in association with each other.

Returning to FIG. 2, the temporary memory 21b includes a RAM such as DRAM or SRAM, to temporarily store (i.e., hold) data, for example. For example, the temporary memory 21b holds an input sentence, a translated sentence, user information described later, and the like. Further, the temporary memory 21b may function as a work area of the controller 20, or may include a storage area in the internal memory of the controller 20.

The operation member 22 is a user interface for operations by the user. The operation member 22 may form a touch panel together with the display 23. The operation member 22 is not limited to the touch panel, and may be, for example, a keyboard, a touch pad, buttons, switches, or the like. The operation member 22 is an example of an input interface that acquires various information input by the user's operation.

The display 23 is an example of an output module which is a liquid crystal display or an organic EL display, for example. For example, the display 23 displays an image including the above-mentioned display areas A1 and A2. Further, the display 23 may display various information such as various icons for operating the operation member 22 and information input from the operation member 22.

The device I/F 24 is a circuit for connecting an external device to the translation device 2. The device I/F is an example of a communication module that performs data-communication according to a predetermined communication standard. The predetermined standards include USE, HDMI (registered trademark), IEEE1395, WiFi, Bluetooth (registered trademark), and the like. The device I/F 24 may be an input interface for receiving various information or an output module for transmitting various information in the translation device 2 from/to the external device.

The network I/F 23 is a circuit for connecting the translation device 2 to the communication network 10 via a wireless or wired communication line. The network I/F 23 is an example of a communication module that performs data-communication conforming to a predetermined communication standard. The redetermined communication standards include communication standards such as IEEE802.3 and IEEE802.11a/11b/11g/11ac. The network I/F 23 may be an input interface for receiving various information or an output module for transmitting various information in the translation device 2 via the communication network 10.

The microphone 26 is an example of an input interface that collects voice to generate audio data. The translation device 2 may have a voice recognition function, and for example, may recognize audio data generated by the microphone 26 to convert the voice into text data.

The speaker 27 is an example of an output module that outputs audio data by voice. The translation device 2 may have a voice synthesis function, and for example, may synthesize voice from the text data based on machine translation to output the voice from the speaker 27.

The configuration of the translation device 2 as described above is an example, and the configuration of the translation device 2 is not limited thereto. The translation device 2 may include various computers, not limited to the information terminal. Further, the input interface in the translation device 2 may be realized in cooperation with various software in the controller 20 and the like. The input interface in the translation device 2 may acquire various information by reading various information stored in various storage media (e.g., storage 21a) into the work area (e.g., temporary memory 21b) of the controller 20.

1-3. Configuration of translation server

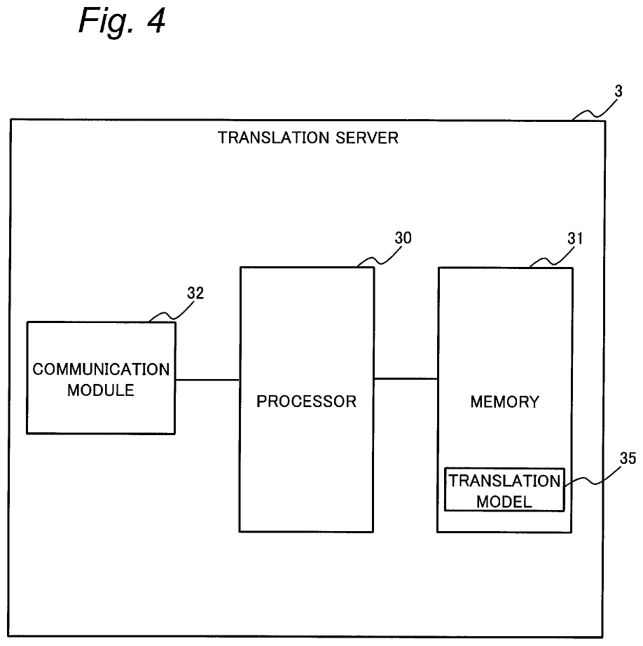

As an example of the hardware configurations of the various servers in the translation system 1 of the present embodiment, the configuration of the translation server 3 will be described with reference to FIG. 4. FIG. 4 is a block diagram illustrating the configuration of the translation server 3 in the present embodiment.

The translation server 3 illustrated in FIG. 4 includes a processor 30, a memory 31, and a communication module 32. The translation server 3 is one or more computers.

The processor 30 includes a CPU and a GPU that realize a predetermined function in cooperation with software, to control the operation of the translation server 3, for example. The processor 30 reads data and programs stored in the memory 31, and performs various arithmetic processes to realize various functions.

For example, the processor 30 executes a program of a translation model 35 that executes machine translation in the present embodiment. The translation model 35 is various neural networks, for example. For example, the translation model 35 is an attention neural machine translation model that realizes machine translation between bilingual languages based on a so-called attention mechanism (see, e.g., Dzmitry Bandanau et al.: “Neural Machine Translation by Jointly Learning to Align and Translate”, arXiv preprint arXiv:1409.0473, September 2014). The translation model 35 may be a model shared among multiple languages, or may include a model different for each language of the translation source and the translation destination. The processor 30 may execute a program for performing machine learning of the translation model 35. Each of the above programs may be provided from the communication network 10 or the like, or may be stored in a portable recording medium.

Note that, the processor 30 may be a hardware circuit such as a dedicated electronic circuit designed to realize a predetermined function or a reconfigurable electronic circuit. The processor 30 may include various semiconductor integrated circuits such as a CPU, GPU, TPU, MPU, microcomputer, DSP, FPGA, and ASIC.

The memory 31 is a storage medium for storing programs and data necessary for realizing the functions of the translation server 3, and includes an HDD or an SSD, for example. For example the memory 31 may include DRAM or SRAM, and may function as a work area of the processor 30. The memory 31 stores a program of the translation model 35 and various parameter groups that define the translation model 35 based on machine learning, for example. The parameter group includes various weight parameters of the neural network, for example.

The communication module 32 is an I/F circuit for performing data-communication according to a predetermined communication standard, and connects the translation server 3 to the communication network 10, an external device, or the like by data-communication. The predetermined communication standards include IEEE802.3, IEEE802.11a/11b/11g/11ac, USB, HDMI, IEEE1395, WiFi, Bluetooth, and the like.

The translation server 3 in the translation system 1 is not limited to the above configuration, and may have various configurations. The translation method of the present embodiment may be executed in cloud computing.

2. Operation

The operations of the translation system 1 and the translation device 2 configured as described above will be described below.

2-1. Overall operation

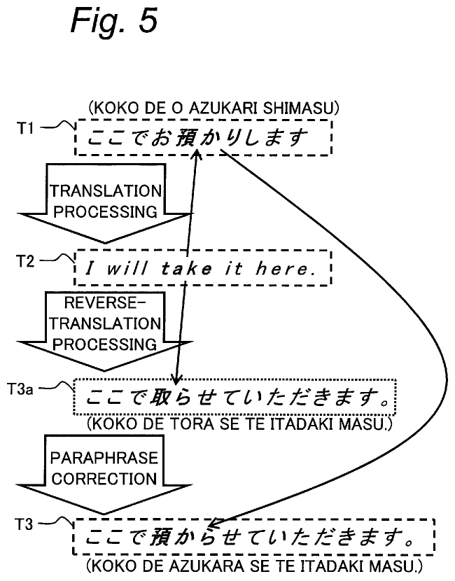

The operation of the translation system 1 according to the present embodiment will be described with reference to FIGS. 1 and 5. FIG. 5 is a diagram for explaining the operation of the translation system 1.

The translation system 1 of the present embodiment inputs the desired input sentence T1 of the user 5 from the translation device 2. In the translation system 1, the translation server 3 receives information indicating the input sentence T1, the target language or the like from the translation device 2, to execute translation processing of mechanically translating the input sentence T1 from the source language into the target language. The translation processing is executed, for example, by inputting information from the translation device 2 into the translation model 35. The translation server 3 generates the translated sentence T2 as a result of the translation processing and transmits the translated sentence T2 to the translation device 2.

Further, in the present embodiment, the translation server 3 performs reverse-translation processing of mechanically translating the translated sentence T2 and returning it to the source language. The reverse-translation processing can be executed in the same manner as the above translation processing by the translation server 3 receiving information indicating the translated sentence T2, the source language, and the like from the translation device 2, for example. The translation server 3 generates a reverse-translated sentence T3a as a result of the reverse-translation processing and transmits the reverse-translated sentence T3a to the translation device 2. The translation device 2 outputs the translation result to the user 5.

FIG. 5 shows an example of the operation of the translation system 1 as described above. In the following, an example in which the source language is Japanese and the target language is English will be described.

In the example of FIG. 5, the translation processing is performed on the input sentence T1 “Koko de o azukari shimasu”, and as a result, the translated sentence T2 “I will take it here.” is generated. In addition, the reverse-translation processing is performed on the translated sentence T2, and as a result, the reverse-translated sentence T3a “Koko de tora se to itadaki masu.” is generated.

In this example, the translated sentence T2 accurately translates the input sentence T1 without any particular mistranslation, and the translation processing by the translation server 3 is successful. Also, the reverse-translated sentence T3a accurately translates the translated sentence T2 without any particular mistranslation, and the reverse-translation processing is successful. However, according to “tora” in the reverse-translated sentence T3a and “azukari” in the input sentence T1, the reverse-translated sentence T3a and the input sentence T1 are deviated so as to their meaning is far apart.

According to the reverse-translated sentence T3a, which deviates from the input sentence T1 as described above, there is concern that the user 5 would misunderstand as if the machine translation has failed, even though the translation processing and the reverse-translation processing by the translation server 3 are individually successful. It is considered that such a situation is caused by the inclusion of polysemous words having multiple meanings, such as “take” in the translated sentence T2.

To this end, the translation device 2 of the present embodiment corrects the part in the reverse-translated sentence T3a that is different from the input sentence T1 due to the polysemous word in the translated sentence T2 so as to paraphrase the part in accordance with the input sentence T1. FIG. 5 illustrates the corrected reverse-translated sentence T3.

In the example of FIG. 5, although the corrected reverse-translated sentence T3 has a different wording from the input sentence T1, such as “Koko de azukara se to itadaki masu.”, the corrected reverse-translated sentence T3 does not deviate in meaning and is consistent with the input sentence T1. The translation device 2 of the present embodiment can avoid the above-mentioned misunderstanding of the user by displaying the reverse-translated sentence T3 of the correction result in the display area A1 for the user (FIG. 1). The details of the operation of the translation device 2 will be described below.

2-2. Operation of translation device

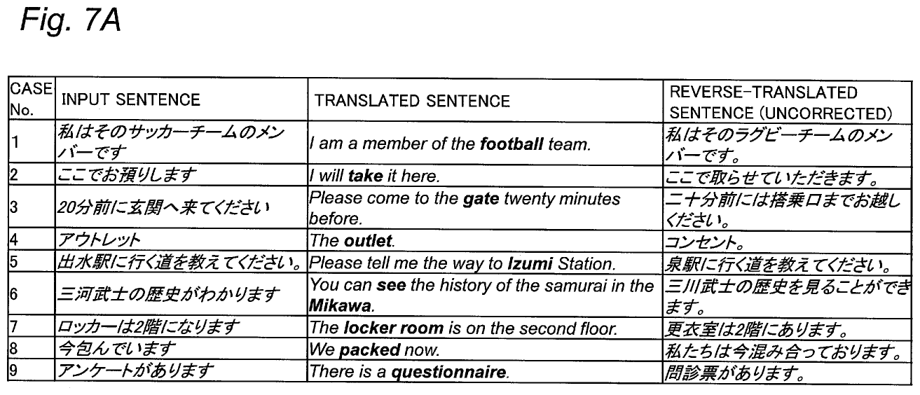

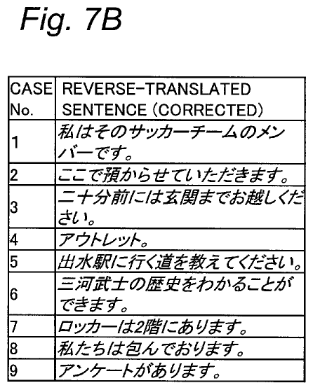

The details of the operation of the translation device 2 according to the present embodiment will be described with reference to FIGS. 6 to 7B.

FIG. 6 is a flowchart showing the operation of the translation device 2 according to the present embodiment. FIG. 7A is a table illustrating various information acquired in the operation of the translation device 2. FIG. 7B is a table illustrating the reverse-translated sentence T3 of the correction result based on the information in FIG. 7A.

Each processing of the flowchart shown in FIG. 6 is executed by the controller 20 of the translation device 2. This flowchart is started in response to the operation of the user 5, for example.

At first, the controller 20 of the translation device 2 acquires the input sentence T1 by the operation of the operation member 22 by the user 5, for example (S1). The processing of step S1 may be performed by using various input interfaces, not limited to the operation member 22, such as the microphone 26, the network I/F 23, and the device I/F 24. For example, the utterance voice or the like of the user 5 from the microphone 26 may be input by voice, or the input sentence T1 may be acquired based on voice recognition. FIG. 7A illustrates the input sentence T1 acquired in step S1 in various cases.

Next, the controller 20 transmits the information including the acquired input sentence T1 to the translation server 3 via the network I/F 23, and acquires the translated sentence T2 as a response from the translation server 3 (S2). The translation server 3 can transmit various additional information to the translation device 2 together with the translated sentence T2. For example, the attention score at the translation processing can be included as additional information. FIG. 7A illustrates the translated sentence T2 corresponding to the input sentence T1 in each case. The translated sentence T2 of this example includes polysemous words as shown in bold.

Next, the controller 20 acquires the reverse-translated sentence T3a generated as a result of the reverse-translation processing for the translated sentence T2 from the translation server 3 via the network I/F 23 (S3). FIG. 7A illustrates the reverse-translated sentence T3a generated according to the input sentence T1 and the translated sentence T2. The reverse-translated sentence T3a of this example deviates from the input sentence T1 due to the polysemous word.

Next, the controller 20 corrects the paraphrase of the reverse-translated sentence based on the acquired input sentence T1 and translated sentence T2 (S4). The paraphrase correction of the reverse-translated sentence is processing of correcting the acquired reverse-translated sentence T3a so as to paraphrase it in accordance with the input sentence T1. FIG. 7B shows the reverse-translated sentence T3 after paraphrase correction for the reverse-translated sentence T3a of the example of FIG. 7A. The processing of paraphrase correction of the reverse-translated sentence in step S4 will be described later.

Next, the controller 20 causes the display 23 to display the input sentence T1, the translated sentence T2, and the corrected reverse-translated sentence T3 as the output of the translation result in the translation system 1 (S5). The translation result is not limited to the display on the display 23, but can be output by various means such as audio output from the speaker 27 or data transmission to an external device.

The controller 20 of the translation device 2 ends the processing according to this flowchart by outputting the translation result (S5).

According to the above operation of the translation device 2, as shown in FIG. 7A, the reverse-translated sentence T3a deviating from the input sentence T1 due to the polysemous word in the translated sentence T2 is automatically paraphrased and output (S5) as shown in FIG. 7B by the paraphrase correction of the reverse-translated sentence (S4). At this time, the processing can be completed automatically without the intervention of the operation of the user 5 or the like.

2-2-1. Paraphrase correction of reverse-translated sentence

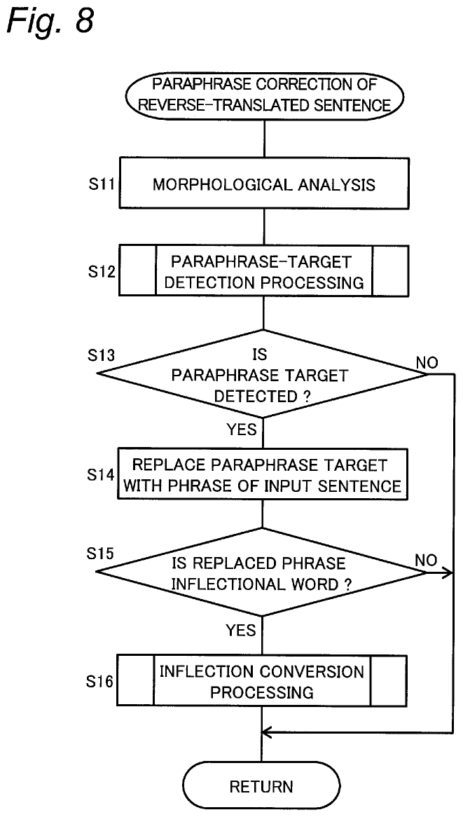

The processing of paraphrase correction (S4 in FIG. 6) of the reverse-translated sentence in step S4 in FIG. 6 will be described with reference to FIG. 8.

FIG. 8 is a flowchart illustrating the processing of paraphrase correction of the reverse-translated sentence in the translation device 2. The flowchart of FIG. 8 is executed after each sentence T1, T2, and T3a is acquired in steps S1 to S3 of FIG. 6.

At first, the controller 20 performs morphological analysis on each of the input sentence T1, the translated sentence T2, and the reverse-translated sentence T3a, for example (S11). Note that some or all of the processing in step S11 may be omitted as appropriate.

Next, the controller 20 performs a paraphrase-target detection processing in the reverse-translated sentence T3a (S12). In this processing, the translated word in the reverse-translated sentence T3, which is presumed to deviate from the input sentence T1 due to the polysemous word in the translated sentence T2, is detected as a paraphrase target.

For example, in the example of case number “1” in FIG. 7A, since “football” in the translated sentence T2 is a polysemous word, the corresponding word “ragubi (rugby)” in the reverse-translated sentence T3 is different from the corresponding word “sakka (soccer)” in the input sentence T1. In step S12, the controller 20 associates the words in each of the input sentence T1, the translated sentence T2, and the reverse-translated sentence T3a with each other, and detects the translated word “ragubi (rugby)” to be paraphrased in the above reverse-translated sentence T3. Note that, the “phrase” to be processed for paraphrase correction may be one word or a morpheme, or may include a plurality of words and the like. The details of processing of step S12 will be described later.

When the controller 20 detects the translated word to be paraphrased as a result of the processing in step S12 (YES in S13), the controller 20 replaces the translated word to be paraphrased in the reverse-translated sentence T3 with the corresponding word in the input sentence T1 (S14). As a result, in the above example, the translated word “ragubi (rugby)” in the reverse-translated sentence T3 is paraphrased into “sakka (soccer)”, for example.

Here, a case is conceivable where the connection or the like before and after the phrase replaced in the sentence would be unnatural by applying the processing of step S14 to inflectional words such as verbs and adjectives. To address this, the controller 20 determines whether or not the replaced phrase in step S14 is an inflectional word, for example (S15). For example, as “sakka (soccer)” is a noun and not an inflectional word in the above example, the controller 20 proceeds to NO in step S15. Note that the determination in step S15 may use the phrase to be paraphrased before replacement in step S14.

When determining that the replaced phrase is an inflectional word (YES in S15), the controller 20 performs the inflection conversion processing (S16). In this processing, the controller 20 performs inflection form conversion or the like on a part or all of the phrases in the reverse-translated sentence after the replacement to smooth the context of the replaced part. The details of the inflection conversion processing (S16) will be described later.

The controller 20 ends step S4 in FIG. 6 with the reverse-translated sentence T3 smoothed by the inflection conversion processing as the correction result. In the subsequent step S5, the reverse-translated sentence T3 of the correction result is output.

On the other hand, when determining that the replaced phrase is not an inflectional word (NO in S15), the controller 20 ends step S4 in FIG. 6 without performing the inflection conversion processing (S16). In this case, the replacement result in step S14 is the correction result.

Further, when the paraphrase target is not detected (NO in S13), the controller 20 ends step S4 in FIG. 6 without performing processing of steps S14 to S16. In this case, the reverse-translated sentence T3 displayed in step S5 is not particularly changed from the reverse-translated sentence T3a acquired in step S3.

According to the above processing, it is possible to obtain accurately corrected reverse-translated sentence T3 by a simple processing of replacing the translation deviation caused by the polysemous words in the translated sentence T2 with the phrase of the input sentence T1 in the reverse-translated sentence T3a generated by the reverse-translation processing.

In addition, even when inflectional words such as verbs are paraphrased, the reverse-translated sentence T3 of the correction result can be made not unnatural by the inflection conversion processing (S16). Note that, the determination in step S15 may be omitted, and the controller 20 may proceed to step S16 after step S14.

2-2-2. Paraphrase-target detection processing

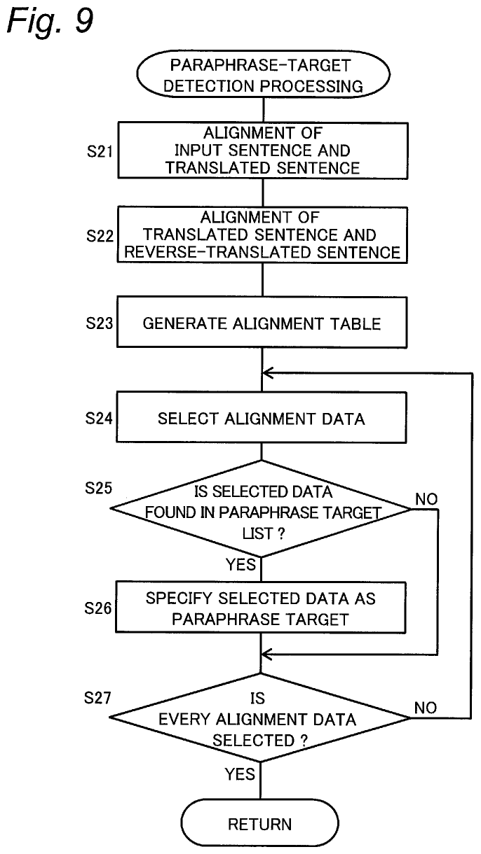

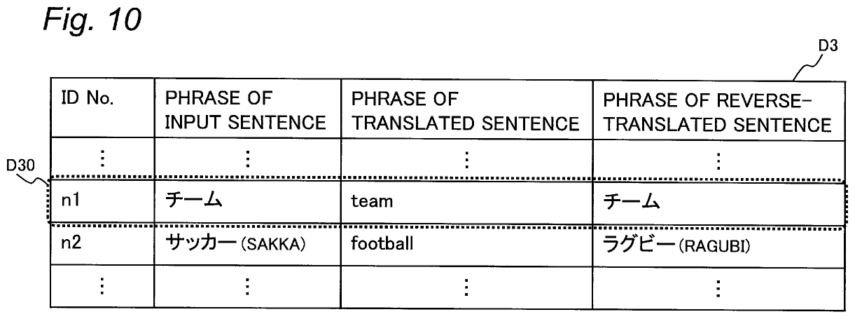

The details of the paraphrase-target detection processing (S12 in FIG. 8) in the first embodiment will be described with reference to FIGS. 9 and 10. In the following, an example of processing performed with reference to the paraphrase target list D1 in FIG. 3 will be described.

FIG. 9 is a flowchart illustrating the paraphrase-target detection processing in the present embodiment. FIG. 10 is a diagram illustrating an alignment table used for the paraphrase-detection processing of the present embodiment.

At first, the controller 20 aligns input sentence T1 to the translated sentence T2 (S21). Alignment is processing of organizing a set of phrases that are in a relation of parallel translation between two sentences. The processing of step S21 can be performed by associating phrases with higher attention scores (see Dzmitry Bandanau et al.) obtained in the translation processing by the translation model 35, for example. The phrases to be aligned are not limited to words, and can be set at various vocabulary particle sizes preset in machine translation such as subwords based on Byte Pair Encoding.

In addition, the controller 20 aligns the translated sentence T2 to the reverse-translated sentence T3a (S22). The processing of step S22 can be performed using the attention score obtained during the reverse-translation processing, for example. Note that the order of processing in steps S21 and S22 is not particularly limited.

The controller 20 generates an alignment table D3 as a result of the processing in steps S21 and S22, as shown in FIG. 10, for example (S23). The alignment table D3 records the phrase in the input sentence T1, the phrase in the translated sentence T2, and the phrase in the reverse-translated sentence T3a in association with each other into the alignment data D30 for each identification number.

The example of FIG. 10 illustrates the case where the reverse-translated sentence T3a of the case number “1” of FIG. 7A is acquired in step S3 of FIG. 6. In this example, the alignment data D30 of the identification number n2 associates the word “sakka (soccer)” in the input sentence T1, the word “football” in the translated sentence T2, and the word “ragubi (rugby)” in the reverse-translated sentence T3 with each other. In step S23, the controller 20 may limit the recording in the table D3 to candidates to be paraphrased, or may limit the recording to a specific part of speech such as nouns and verbs.

Returning to FIG. 9, the controller 20 selects one alignment data D30 from the alignment table D3 in order by the identification number, for example (S24).

Next, the controller 20, referring to the paraphrase target list D1 stored in the memory 21, determines whether or not the selected alignment data D30 is found in the paraphrase target list D1 (S25). The determination in step S25 is made depending on whether or not the phrase of the translated sentence in the alignment data D30 is included in the polysemous words in the paraphrase target list D1, and the phrases of the input sentence and the reverse-translated sentence in the same data D30 are included in the bilingual vocabulary of the polysemous words.

For example, when the alignment data D30 of the above identification number n2 is selected, the controller proceeds to YES in step S25 based on the “football” registered in the polysemous word in the paraphrase target list D1 of FIG. 3 and the corresponding bilingual vocabularies “sakka (soccer)” and “ragubi (rugby)”. On the other hand, when at least one of the phrase of the input sentence, the phrase of the translated sentence, and the phrase of the reverse-translated sentence in the selected alignment data D30 is not included in the paraphrase target list D1, the controller 20 proceeds to NO in step S25.

Further, when the word of the input sentence and the word of the reverse-translated sentence in the alignment data D30 are the same, the controller 20 proceeds to NO in step S25. The determination in step S25 can be made by ignoring the difference or the like in the inflection form of each word. By the determination in step S25, the difference between the input sentence T1 and the reverse-translated sentence T3a due to the polysemous word is detected.

When determining that the selected alignment data D30 is found in the paraphrase target list D1 (YES in S25), the controller 20 specifies the phrase in the reverse-translated sentence in the alignment data D30 as the paraphrase target (S26).

The controller 20 determines whether or not all the alignment data D30 in the alignment table D3 are selected, for example (S27). When unselected alignment data D30 is found (NO in S27), the controller 20 performs the processing in and after step S21 on the unselected alignment data. As a result, it is detected whether or not each phrase in the reverse-translated sentence T3a is a paraphrase target.

Note that, when determining that the selected alignment data D30 is not found in the paraphrase target list D1 (NO in S25), the controller 20 does not perform the processing of step S26 and proceeds to step S27.

After selecting all the alignment data D30 in the alignment table D3 (S27 in YES), the controller 20 ends step S12 in FIG. 8. In the subsequent step S14, the paraphrase replacement is performed based on the detection result that is the phrase specified as the paraphrase target.

According to the above processing, by detecting the difference between the input sentence T1 and the reverse-translated sentence T3a caused by the polysemous word with reference to the paraphrase target list D1 (S25), the appropriate paraphrase target can be detected accurately.

For example, in a case where the translation processing from the input sentence T1 to the translated sentence T2 fails, so that the reverse-translated sentence T3 deviate from the input sentence T1 due to a mistranslation in the translated sentence T2, it is unreasonable to paraphrase the reverse-translated sentence T3 in accordance with the input sentence T1. In such a case, as not found in the paraphrase target list D1 in step S25, it is possible to prevent erroneous detection as a paraphrase target.

In the processing of steps S21 and S22, the attention score may be provided with a threshold value for whether or not to perform association. Further, the alignment may be performed by a method independent of the translation model 35 that executes the translation processing, and a method in statistical machine translation such as an IBM model or a hidden Markov model may be adopted. In this case, when a mistranslation occurs, the mistranslated portion can be excluded from the paraphrase target so that it is not associated at the alignment processing.

2-2-3. Inflection conversion processing

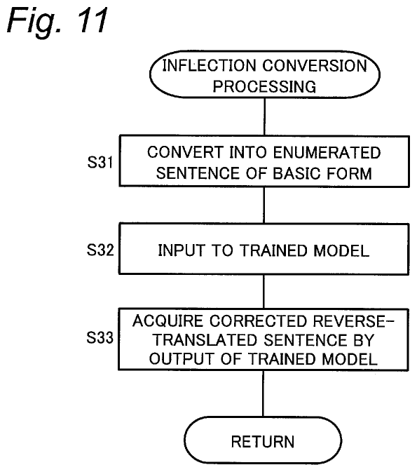

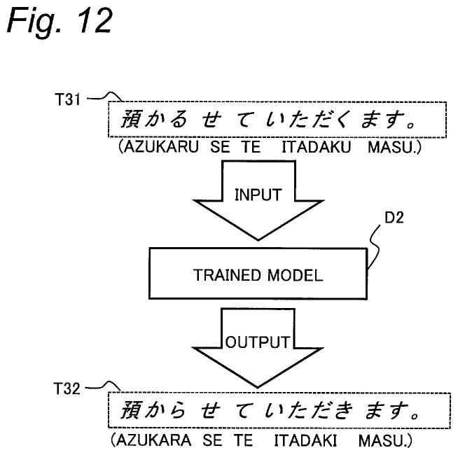

The details of the inflection conversion processing (S16 in FIG. 8) in the first embodiment will be described with reference to FIGS. 11 and 12. In the following, an example of realizing the inflection conversion processing by the trained model D2 in which the conversion from an unnatural sentence to a fluent sentence is machine-learned will be described.

FIG. 11 is a flowchart illustrating the inflection conversion processing in the present embodiment. FIG. 12 is a diagram for explaining the trained model D2 used for the inflection conversion processing of the present embodiment. The flowchart of FIG. 11 is performed in a state where the trained model D2, which is obtained by machine learning in advance, is stored in the memory 21.

At first, the controller 20 converts a part or the whole of the reverse-translated sentence, which is after the replacement in step S14 of FIG. 8, into a sentence in which the basic-form words in the inflection conversion are enumerated (S31). Hereinafter, the sentence converted as in step S31 is referred to as an “enumerated sentence”. Note that the enumerated sentence is not limited to the basic form, but can be set to enumeration of a predetermined inflection form.

Next, the controller 20 inputs the converted enumerated sentence into the trained model D2 (S32). The trained model D2 realizes language processing that outputs a fluent sentence when an enumerated sentence is input. FIG. 12 shows an example of language processing by the trained model D2.

In the example of FIG. 12, an enumerated sentence T31 including “azukaru”, “se”, “te”, “itadaku”, and “masu” is input into the trained model D2 as an enumeration of basic form words. In this example, the trained model D2 outputs a fluent sentence T32 of “azukara se to itadaki masu” based on the input enumerated sentence T31.

Next, the controller 20 executes language processing by the trained model D2, and acquires the reverse-translated sentence T3 of the correction result from the output of the trained model D2 (S33). As a result, the controller 20 ends step S16 in FIG. 8.

According to the above inflection conversion processing, the language processing of the trained model D2 can realize smoothing that resolves the unnaturalness of the reverse-translated sentence after replacement, and a fluent reverse-translated sentence T3 can be obtained.

The trained model D2 as described above can be configured in the same manner as a machine translator based on machine learning. For example, various structures used as a machine translator, such as various recurrent neural networks, can be applied to the structure of the trained model D2. The machine learning of the model 35 can be performed by using data in which various enumerated sentences and sentences fluent enough to output the same contents as the enumerated sentences are associated with each other, instead of the bilingual corpus used for the training data of the machine translator.

3. Summary

As described above, the translation device 2 according to the present embodiment includes an input interface such as an operation member 22 and a controller 20. The input interface acquires an input sentence T1 in the first language (S1). The controller 20 controls machine translation for the input sentence T1 acquired by the input interface. The controller 20 acquires, based on the input sentence T1, a translated sentence T2 indicating the result of machine translation of the input sentence T1 from the first language to the second language (S2), and acquires, based on the translated sentence T2, a reverse-translated sentence T3a indicating the result of machine translation of the translated sentence T2 from the second language to the first language (S3). The controller 20 corrects, based on the input sentence T1, a part including a translated word corresponding to a polysemous word in the translated sentence T2 in the acquired reverse-translated sentence T3a so as to change the translated word to a phrase corresponding to the polysemous word in the input sentence T1 in the acquired reverse-translated sentence T3a (S4).

According to the above translation device 2, the accuracy of the reverse-translated sentence T3 can be improved by simple processing of partially correcting the reverse-translated sentence T3a as a result of the machine translation in accordance with the input sentence T1.

In the present embodiment, the controller 20 detects the difference between the acquired reverse-translated sentence T3a and the input sentence T1 according to the polysemous word in the translated sentence T2 (S25), and corrects the reverse-translated sentence T3a. As a result, a highly accurate reverse-translated sentence T3 can be obtained by detecting a portion deviating from the input sentence T1 due to the polysemous word of the translated sentence T2 and correcting the portion.

The translation device 2 of the present embodiment further includes a memory 21 that stores a paraphrase target list D1 which is an example of a data list in which the polysemous word in the second language and the translated word of the polysemous word in the first language are associated with each other. The controller 20 detects the difference according to the polysemous word with reference to the paraphrase target list D1 (S25). By registering the polysemous word to be corrected in the paraphrase target list D1 in advance, it is possible to correct the reverse-translated sentence T3a with high accuracy.

In the present embodiment, the controller 20 replaces the translated word corresponding to the polysemous word in the acquired reverse-translated sentence T3a with the phrase corresponding to the polysemous word in the input sentence T1 (S14), and converts the inflection form of the part including the phrase replaced in the reverse-translated sentence T3a to acquire the correction result of the reverse-translated sentence T3a (S16). Accurate reverse-translated sentence T3 can be obtained even when inflectional words such as verbs are corrected as paraphrase targets.

In the present embodiment, the controller 20 inputs an enumerated sentence into the trained model D2 as an example of a sentence in which the part including the replaced phrase in the reverse-translated sentence T3a is converted into a predetermined inflection form (S32), and acquires the correction result of the reverse-translated sentence T3a by the output from the trained model D2 (S33). The trained model D2 is obtained by machine-learning so as to output a fluent sentence when inputting a sentence in which phrases of the predetermined inflection form in the first language are lined up. In the machine learning, the degree of fluency acquired by the trained model D2 can be set as appropriate. For example, the trained model D2 can output a more fluent sentence than a sentence in which phrases of a predetermined inflection form are lined up. In the fluent sentence T31 obtained by the trained model D2, the reverse-translated sentence T3 of the correction result can be obtained.

The translation method of the present embodiment is a method executed by a computer such as a translation device 2. This method includes acquiring, by a computer, an input sentence T1 in a first language, acquiring, by the computer, based on the input sentence T1, a translated sentence T2 showing a result of machine translation of the input sentence T1 from the first language to a second language, and acquiring, by the computer, based on the translated sentence T2, a reverse-translated sentence T3a showing a result of machine translation of the translated sentence T2 from the second language to the first language. This method includes correcting, by the computer, based on the input sentence T1, a part including a translated word corresponding to a polysemous word in the translated sentence T2 in the acquired reverse-translated sentence T3a so as to change the translated word to a phrase corresponding to the polysemous word in the input sentence T1 in the reverse-translated sentence T3a.

In the present embodiment, a program for causing a computer to execute the above translation method is provided. According to the above translation method, the accuracy of the reverse-translated sentence T3 with respect to the translated sentence T2 in which the input sentence T1 is mechanically translated can be improved.

### Other Embodiments

As described above, the first embodiment has been described as an example of the technique disclosed in the present application. However, the technology in the present disclosure is not limited thereto, and can also be applied to embodiments in which changes, substitutions, additions, omissions, and the like have been made as appropriate. Further, it is also possible to combine the components described in the above embodiments to form a new embodiment. Accordingly, other embodiments will be exemplified below.

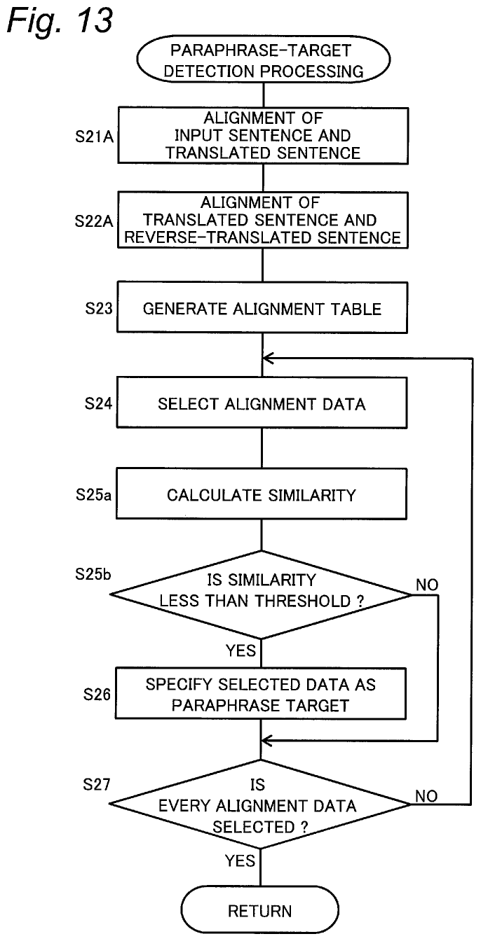

In the first embodiment described above, the paraphrase-target detection processing (FIG. 9) for detecting the difference between the input sentence T1 and the reverse-translated sentence T3a, i.e. the fluctuation of the meaning, has been exemplified by using the paraphrase target list D1. A modified example in which the paraphrase target list D1 is not used will be described with reference to FIGS. 13 to 15.

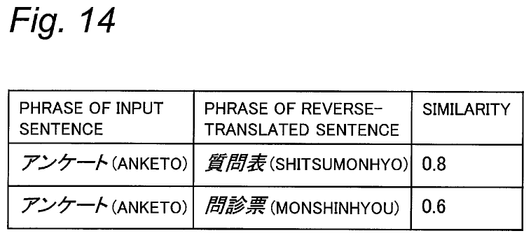

FIG. 13 is a flowchart showing a first modification of the paraphrase-target detection processing. FIG. 14 is a diagram for explaining the first modification of the paraphrase-target detection processing. In this modification, instead of step S25 in the same processing as in FIG. 9, the controller 20 calculates the similarity between the word of the input sentence and the word of the reverse-translated sentence in the alignment data D30 (S25a). A word distributed expression such as Word2Vec or Glove can be used to calculate the similarity.

When the calculated similarity is less than a predetermined threshold value (YES in S25b), the controller 20 specifies a paraphrase target (S26). The predetermined threshold value is set to a value at which the presence or absence of a fluctuation in meaning is to be detected, for example. FIG. 14 illustrates the case where the word in the reverse-translated sentence is the “shitsumonhyo” and the case where the word is the “monshinhyo” with respect to the word “anketo” in the input sentence. For example, when the threshold value is set to “0.7”, for the former, the similarity 0.8 is larger than the threshold value, so that no fluctuation in meaning is detected (NO in S25b). On the other hand, for the latter, the similarity 0.6 is smaller than the threshold value, so that a fluctuation in meaning is detected (YES in S25b).

In this modification, the method as described above is adopted in the alignment steps S21A and S22A, wherein the method makes the mistranslated portion not associate even when mistranslation occurs. According to this modification, the fluctuation of meaning detected in step S25b, that is, the difference between the input sentence T1 and the reverse-translated sentence T3a can be limited to those caused by the translated sentence T2 instead of the mistranslation.

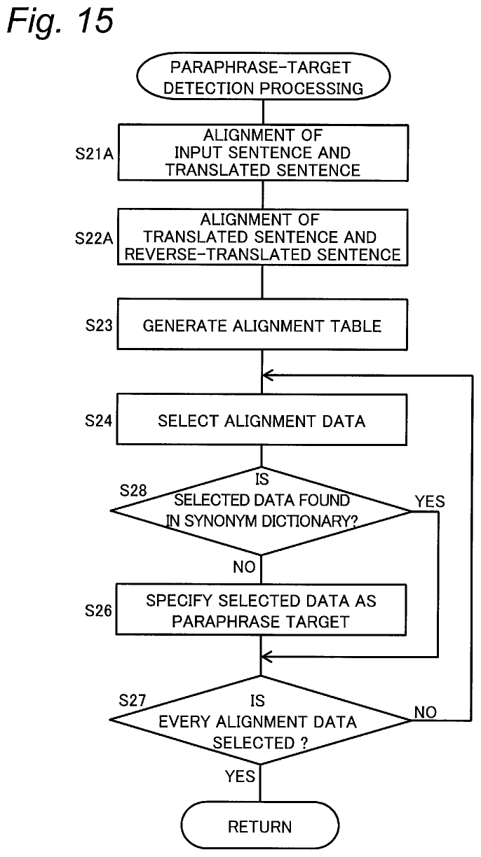

FIG. 15 is a flowchart showing a second modification of the paraphrase-target detection processing. In this modification, a synonym dictionary is used instead of steps S25a and S25b in the same processing as in FIG. 13 (S28). The synonym dictionary registers words with similar meanings as synonyms, such as the “anketo” and “monshinhyou” in the above example. Therefore, when the word of the input sentence and the word of the reverse-translated sentence in the alignment data D30 are not registered as synonyms in the synonym dictionary (NO in S28), it is expected that a fluctuation in meaning occurs, so the controller 20 specifies a paraphrase target (S26). As the synonym dictionary WordNet or the like can be used, for example.

In the above embodiment, the trained model D2 with the conversion to a fluent sentence being machine-learned is used for the inflection conversion processing (FIG. 11), but the inflection conversion processing may be performed by another method. For example, a language model score that represents an index showing the co-occurrence of adjacent words in a sentence may be used. For example, the controller 20 may calculate the language model score with transforming the inflection based on the grammatical rules of the source language with respect to the inflection form of the phrase replaced in step S14, instead of the flowchart of FIG. 11. In this case, the controller 20 can select a sentence of the inflection form having the highest language model score and obtain the reverse-translated sentence T3 of the correction result.

Further, in each of the above embodiments, an example in which machine translation is performed on the translation server 3 outside the translation device 2 has been described. In this embodiment, machine translation may be performed inside the translation device 2. For example, a program similar to the translation model 35 may be stored in the memory 21 of the translation device 2, and the controller 20 may execute the program. Further, the translation device 2 of the present embodiment may be a server device.

As described above, the embodiments have been described as examples of the technology in the present disclosure. For this purpose, the accompanying drawings and detailed description are provided.

Accordingly, among the components described in the accompanying drawings and the detailed description, not only the components essential for solving the problem, but also the components not essential for solving the problem may also be included in order to exemplify the above technology. Therefore, it may not be immediately recognized that these non-essential components are essential as those non-essential components are described in the accompanying drawings and detailed description.

Moreover, since the above-mentioned embodiments are for demonstrating the technology in the present disclosure, various changes, substitutions, additions, omissions, and the like can be made within the scope of claims or a scope equivalent to the claims.

The present disclosure is applicable to translation devices, translation methods and programs based on various machine translations.

1. A translation device comprising:
an input interface that acquires an input sentence in a first language; and
a controller that controls machine translation for the input sentence acquired by the input interface, wherein
the controller
acquires, based on the input sentence, a translated sentence showing a result of machine translation of the input sentence from the first language to a second language,
acquires, based on the translated sentence, a reverse-translated sentence showing a result of machine translation of the translated sentence from the second language to the first language, and
corrects, based on the input sentence, a part including a translated word in the acquired reverse-translated sentence to change the translated word into a phrase corresponding to a polysemous word in the input sentence, the translated word corresponding to the polysemous word of the translated sentence in the reverse-translated sentence.

2. The translation device according to claim 1, wherein the controller detects a difference between the acquired reverse-translated sentence and the input sentence according to the polysemous word of the translated sentence, to correct the reverse-translated sentence.

3. The translation device according to claim 2, further comprising
a memory that stores a data list in which a polysemous word in the second language and a translated word of the polysemous word in the first language are associated with each other, wherein
the controller detects the difference according to the polysemous word by referring to the data list.

4. The translation device according to claim 1, wherein
the controller
replaces the translated word corresponding to the polysemous word in the acquired reverse-translated sentence with the phrase corresponding to the polysemous word in the input sentence, and
acquires a correction result of the reverse-translated sentence by converting an inflection form of a part including the replaced phrase in the reverse-translated sentence.

5. The translation device according to claim 4, wherein
the controller inputs, into a trained model, a sentence in which the part including the replaced phrase in the reverse-translated sentence is converted into a predetermined inflection form, to acquire a correction result of the reverse-translated sentence by an output from the trained model, the trained model being obtained by machine-learning to output a fluent sentence in response to input a sentence in which phrases of the predetermined inflection form in the first language are lined up.

6. A translation method executed by a computer, comprising:
acquiring an input sentence in a first language;
acquiring, based on the input sentence, a translated sentence showing a result of machine translation of the input sentence from the first language to a second language;
acquiring, based on the translated sentence, a reverse-translated sentence showing a result of machine translation of the translated sentence from the second language to the first language; and
correcting, based on the input sentence, a part including a translated word in the acquired reverse-translated sentence to change the translated word into a phrase corresponding to a polysemous word in the input sentence, the translated word corresponding to the polysemous word of the translated sentence in the reverse-translated sentence.

7. A non-transitory computer-readable recording medium storing a program for causing a computer to execute the translation method according to claim 6.
